(19) United States
(12) Patent Application Publication
(10) Pub. No.: US 2025/0296372 A1
(43) Pub. Date: Sep. 25, 2025

(54) DIGITAL PRINTING FILM WINDING STRUCTURE

(71) Applicant: Guangzhou Pulisi Technology Co., Ltd, Guangzhou (CN)

(72) Inventors: Xiaobo Lin, Guangzhou (CN); Lu Liu, Guangzhou (CN); Shengwang Liu, Guangzhou (CN); Zhenhua Meng, Guangzhou (CN); Jingwen Feng, Guangzhou (CN)

(21) Appl. No.: 19/231,451

(22) Filed: Jun. 7, 2025

(30) Foreign Application Priority Data
Jun. 21, 2024 (CN) 202410809592.5

(51) Int. Cl. B41J 15/16; B41J 15/04; F16F 13/00

(52) U.S. Cl. CPC B41J 15/16; B41J 15/046; F16F 13/005

(57) ABSTRACT

A digital printing film winding structure is provided, and belongs to the technical field of film winding in digital printing. A rotatable bracket is arranged on a machine body of a digital printing machine. One end of the bracket is connected to the machine body. An adjustment device is arranged at an other end of the bracket. Then, a roller traction part of the adjustment device is rotatably arranged on the other end of the bracket. A roller of the roller traction part abuts against a winding shaft. As the film is wound, a diameter of a master roll increases, which can reduce the rotation speed of the winding shaft, so as to solve the problem that a tension sensor is easily damaged or easily malfunctions when used in a place with high humidity.

### TECHNICAL FIELD

The present disclosure belongs to the technical field of film winding in digital printing, and in particular, to a digital printing film winding structure.

### BACKGROUND

A film is a thin and soft transparent sheet that needs to be printed on its surface to package different products. Using a printed plastic film for product packaging can not only improve recognition of a product, but also enhance the aesthetics of the product. At present, digital printing is commonly used for film printing. After printing, the film can be automatically wound, so that the printing efficiency is improved.

An existing film winding structure after digital printing is usually arranged on a machine body of a digital printing machine. Then, by using a winding mode, a motor is used to drive a winding shaft to rotate, so that the film is wound onto the winding shaft. During winding of the film, as a diameter of a master roll increases, when a speed of the motor that drives the winding shaft to rotate remains unchanged, winding tension will gradually increase, resulting in a film roll being loose inside and tight outside and an outer-layer film crumpling an inner-layer film. To solve this problem, currently, a winding control system is usually used in conjunction with a tension sensor to control a rotation speed of the motor. However, when the product is used in a place with high humidity, an environmental humidity can affect use of the tension sensor, and the tension sensor is easily damaged or easily malfunctions. Once the tension sensor is damaged or malfunctions, a film roll that is wound later may be loose inside and tight outside, and an outer-layer film can crumple an inner-layer film, which ultimately affects use of the entire film roll. To this end, a digital printing film winding structure is provided.

### SUMMARY

In order to solve the above problems in the existing art, the present disclosure provides a digital printing film winding structure. This solves the following problem: In the existing art, when the product is used in a place with high humidity, an excessive environmental humidity easily causes damage or malfunction to a tension sensor. Once the tension sensor is damaged or malfunctions, a film roll that is wound later may be loose inside and tight outside, and an outer-layer film can crumple an inner-layer film, which ultimately affects the use of the entire film roll.

The objective of the present disclosure can be implemented by the following technical solutions: A digital printing film winding structure includes a winding shaft, a bracket, and an adjustment device; two ends of the winding shaft are rotatably arranged on a machine body of a digital printing machine; one end of the bracket is rotatably arranged on the machine body of the digital printing machine; the adjustment device is arranged on an other end of the bracket; the adjustment device is configured to adjust a winding speed of the winding shaft; the adjustment device includes a roller traction part, a paper pressing roller for pressing a film, and an extensible part connected to the paper pressing roller; the roller traction part is rotatably arranged on the other end of the bracket; a roller of the roller traction part abuts against the winding shaft; the extensible part is arranged on the bracket on one side of the roller traction part, and drives the paper pressing roller to compress a film on the winding shaft; and the roller of the roller traction part drives the winding shaft to rotate through friction with the winding shaft, to cause the winding shaft to automatically adjust a rotation speed.

In a further solution of the present disclosure, the extensible part is arranged at two ends of the paper pressing roller, and the two extensible parts extend and contract synchronously.

In a further solution of the present disclosure, a paper guide roller for winding paper is arranged on the bracket on an other side of the roller traction part.

In a further solution of the present disclosure, an arrangement position of the roller traction part is higher than an arrangement position of the winding shaft.

In a further solution of the present disclosure, the roller traction part includes a traction roller, a speed reducer, and a motor that are rotatably arranged on the bracket; the traction roller is driven by the motor; and the motor is connected to the speed reducer.

In a further solution of the present disclosure, the traction roller is made of solid silicon steel material.

In a further solution of the present disclosure, one end of the bracket is rotatably arranged on the machine body of the digital printing machine through a damping mechanism; the damping mechanism is configured to balance a pressure of the roller traction part on the film on the winding shaft; the damping mechanism includes a two-rack and two-gear transmission part, a tooth ring drive part arranged on the bracket, and a spring part; two ends of the spring part are respectively connected to the tooth ring drive part and one rack of the two-rack and two-gear transmission part, and the tooth ring drive part is meshed with the other rack of the two-rack and two-gear transmission part; by jacking the bracket to drive the tooth ring drive part, the film on the winding shaft rotates; and the tooth ring drive part drives the two-rack and two-gear transmission part to move through the spring part, so that the two-rack and two-gear transmission part balances the pressure on the film on the winding shaft.

In a further solution of the present disclosure, the spring part and the tooth ring drive part are connected to each other through a connecting rod; the connecting rod is located on the tooth ring drive part below the bracket; and the connecting rod is located on a quarter arc below a tooth ring of the tooth ring drive part.

In a further solution of the present disclosure, the two-rack and two-gear transmission part includes a gear and two racks respectively meshed on two sides of the gear; and the two racks are slidably connected to the machine body of the digital printing machine.

In a further solution of the present disclosure, a diameter of the tooth ring of the tooth ring drive part is less than a diameter of the gear.

The present disclosure has the following beneficial effects:

A rotatable bracket is arranged on a machine body of a digital printing machine. One end of the bracket is connected to the machine body. An adjustment device is arranged at an other end of the bracket. Then, a roller traction part of the adjustment device is rotatably arranged on the other end of the bracket. A roller of the roller traction part abuts against a winding shaft. During winding of a film, an extensible part is first adjusted, so that the extensible part drives a paper pressing roller to compress the film on the winding shaft. The gravity of the roller of the roller traction part can act on the winding shaft to compress the winding shaft. When the roller traction part drives the winding shaft to rotate, a center rotation speed of the winding shaft is constant, which is equivalent to keeping a linear speed unchanged in a uniform circular motion. As the film is wound, a diameter of a master roll increases, which can reduce the rotation speed of the winding shaft. Meanwhile, the present disclosure uses the adjustment device to replace a winding control system and cooperate with a tension sensor to control a rotation speed of the motor. In addition, the following problem can also be avoided: A gradual increase of winding tension causes a film roll to be loose inside and tight outside and causes an outer-layer film to crumple an inner-layer film, so as to solve the problem that the tension sensor is easily damaged or easily malfunctions when used in a place with high humidity, which finally affecting use of the entire film roll.

### BRIEF DESCRIPTION OF THE DRAWINGS

For ease of understanding by those skilled in the art, the present disclosure will be further explained below in conjunction with accompanying drawings.

FIG. 1 is a schematic diagram of an entire structure of the present disclosure;

FIG. 2 is a schematic structural diagram of a roller traction part according to the present disclosure;

FIG. 3 is a schematic diagram of film winding according to the present disclosure; and

FIG. 4 is a schematic structural diagram of a damping mechanism according to the present disclosure.

### REFERENCE NUMERALS OF MAIN ELEMENTS

In the drawings: 1: machine body; 2: bracket; 3: adjustment device; 31: roller traction part; 32: paper pressing roller; 33: extensible part; 4: paper guide roller; 5: damping mechanism; 51: two-rack and two-gear transmission part; 52: tooth ring drive part; 53: spring part; 6: connecting rod; 7: film; and 8: winding shaft.

### DETAILED DESCRIPTION OF THE EMBODIMENTS

To further elaborate the technical means and effects used by the present disclosure to achieve preset invention objectives, specific implementations, structures, features, and effects of the present disclosure are described in detail below in conjunction with the accompanying drawings and preferred embodiments.

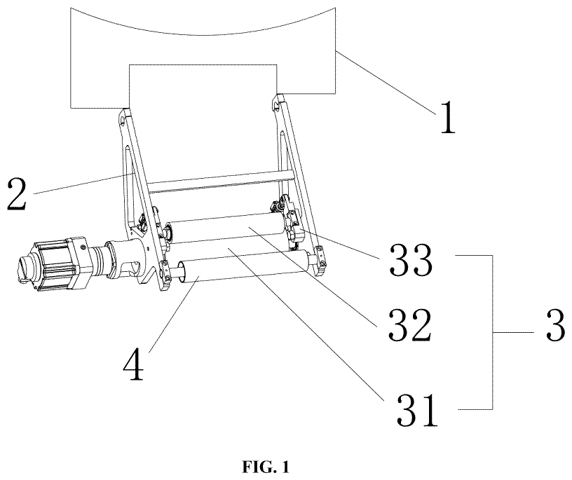

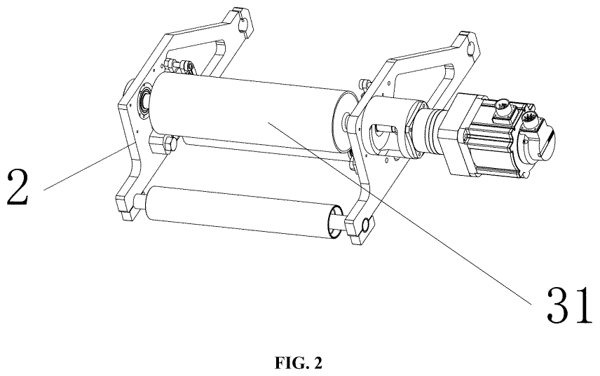

Referring to FIG. 1 to FIG. 4, this embodiment provides a digital printing film winding structure, including a winding shaft 8, a bracket 2, and an adjustment device 3. Two ends of the winding shaft 8 are rotatably arranged on a machine body 1 of a digital printing machine. One end of the bracket 2 is rotatably arranged on the machine body 1 of the digital printing machine, and the adjustment device 3 is arranged at an other end of the bracket 2. The adjustment device 3 is configured to adjust a winding speed of the winding shaft 8. In addition to the winding shaft 8, the machine body 1 of the digital printing machine also includes other parts. Since the present disclosure only optimizes the structure of the winding structure, not all other structures are shown. The adjustment device 3 includes a roller traction part 31, a paper pressing roller 32 for pressing a film 7, and an extensible part 33 connected to the paper pressing roller 32. The roller traction part 31 is rotatably arranged on an other end of the bracket 2. A roller of the roller traction part 31 abuts against the winding shaft 8. The gravity of the roller of the roller traction part 31 herein can act on the winding shaft 8 to compress the winding shaft 8. The extensible part 33 is arranged on the bracket 2 on one side of the roller traction part 31, and drives the paper pressing roller 32 to compress the film 7 on the winding shaft 8. The extensible part 33 is a cylinder that can be controlled to extend and contract to control a degree of compression between the paper pressing roller 32 and the film 7 on the winding shaft 8. The roller of the roller traction part 31 drives the winding shaft 8 to rotate through friction with the winding shaft 8, so that the winding shaft 8 automatically adjusts its rotation speed. The film 7 is sandwiched between the winding shaft 8 and the roller traction part 31 herein. However, due to a material of the film 7 for winding and a force between the film 7 and the winding shaft 8, the roller of the roller traction part 31 here can continuously enable the winding shaft 8 to rotate. There will be no slippage between the winding shaft 8 and the film 7, as well as between the film 7 and the roller traction part 31. When the roller traction part 31 drives the winding shaft 8 to rotate, a center rotation speed of the winding shaft 8 is constant, which is equivalent to keeping a linear speed unchanged in a uniform circular motion. As the film 7 is wound, a diameter of a master roll increases, which can reduce the rotation speed of the winding shaft 8, so as to solve the situation that a gradual increase of winding tension causes a film roll to be loose inside and tight outside and causes an outer-layer film to crumple an inner-layer film. After improvement, a power source here comes from the roller traction part 31. The roller traction part 31 serves as an active power source. The original rotation of the winding shaft 8 is driven by the friction between the roller of the roller traction part 31 and the winding shaft 8. At this time, the winding shaft 8 is changed to have driven motion, and the winding shaft 8 no longer needs to be driven by the motor. Originally, the motor on the winding shaft 8 can be powered off. When the film 7 is not wound, the adjustment device 3 and the bracket 2 are removed. At this time, the motor on the winding shaft 8 can be powered on for ordinary film winding, so that the winding structure of the digital printing machine has higher compatibility.

The current digital printing film winding structure is generally arranged on the machine body 1 of the digital printing machine. Then, by using a winding mode, the motor is used to drive the winding shaft 8 to rotate, so that the film 7 is wound onto the winding shaft 8. However, during winding of the film 7, as a diameter of a master roll increases, when a speed of the motor that drives the winding shaft 8 to rotate remains unchanged, winding tension will gradually increase, resulting in a film roll being loose inside and tight outside and an outer-layer film crumpling an inner-layer film. To solve this problem, currently, a winding control system is usually used in conjunction with a tension sensor to control the rotation speed of the motor. However, when the product is used in a place with high humidity, an environmental humidity can affect use of the tension sensor, and the tension sensor is easily damaged or easily malfunctions. Once the tension sensor is damaged or malfunctions, a film roll that is wound later may be loose inside and tight outside, and an outer-layer film can crumple an inner-layer film, which ultimately affects use of the entire film roll.

To solve the above problem, in this embodiment, a rotatable bracket 2 is arranged on a machine body 1 of a digital printing machine. One end of the bracket 2 is connected to the machine body 1. An adjustment device 3 is arranged at an other end of the bracket 2. Then, a roller traction part 31 of the adjustment device 3 is rotatably arranged on the other end of the bracket 2. A roller of the roller traction part 31 abuts against a winding shaft 8. During winding of a film 7, an extensible part 33 is first adjusted, so that the extensible part 33 drives a paper pressing roller 32 to compress the film 7 on the winding shaft 8. The gravity of the roller of the roller traction part 31 can act on the winding shaft 8 to compress the winding shaft 8. When the roller traction part 31 drives the winding shaft 8 to rotate, a center rotation speed of the winding shaft 8 is constant, which is equivalent to keeping a linear speed unchanged in a uniform circular motion. As the film 7 is wound, a diameter of a master roll increases, which can reduce the rotation speed of the winding shaft 8. Meanwhile, the present disclosure uses the adjustment device 3 to replace a winding control system and cooperate with a tension sensor to control a rotation speed of the motor. In addition, the following problem can also be avoided: A gradual increase of winding tension causes a film roll to be loose inside and tight outside and causes an outer-layer film 7 to crumple an inner-layer film 7, so as to solve the problem: When the product is used in a place with high humidity, an environmental humidity can affect use of the tension sensor and easily causes damage or malfunction to the tension sensor. Once the tension sensor is damaged or malfunctions, a film roll that is wound later may be loose inside and tight outside, and an outer-layer film can crumple an inner-layer film, which ultimately affects the use of the entire film roll.

During the winding of the film 7, the paper pressing roller 32 needs to compress the film 7. The winding shaft 8 generates vibrations during rotation. The vibrations can easily be transmitted to the paper pressing roller 32, causing that a degree of compression between the entire paper pressing roller 32 and the film 7 on every point is not the same. Once the degree of compression changes, this can easily lead to poor winding quality of the film 7, and due to the vibrations, it is the most likely that points with different degrees of compression between the paper pressing roller 32 and the film 7 are at two ends of the paper pressing roller 32. In an embodiment, extensible parts 33 are arranged at two ends of the paper pressing roller 32, and the two extensible parts 33 extend and contract synchronously. Since the two extensible parts 33 that extend and contract synchronously are arranged at the two ends of the paper pressing roller 32, after the paper pressing roller 32 compresses the film 7, even if the winding shaft 8 generates the vibrations during rotation, the extensible parts 33 limit the movement of the paper pressing roller 32, which causes the degree of compression between the paper pressing roller 32 and the film 7 at each point to be the same and ensures the winding quality of the film 7.

In addition, during actual use, during the winding of the film 7, in addition to the winding shaft 8, a paper guide roller 4 can be also provided, which is convenient for paper guidance. However, after the bracket 2 and the adjustment device 3 are added, paper feeding interference needs to be further considered. To this end, in an embodiment, a paper guide roller 4 for paper winding is mounted on the bracket 2 on an other side of the roller traction part 31. The paper guide roller 4 is added based on an original paper guide roller 4 and will not conflict with the original paper guide roller 4. Furthermore, this paper guide roller 4 is designed to avoid the paper feeding interference after the bracket 2 and the adjustment device 3 are added.

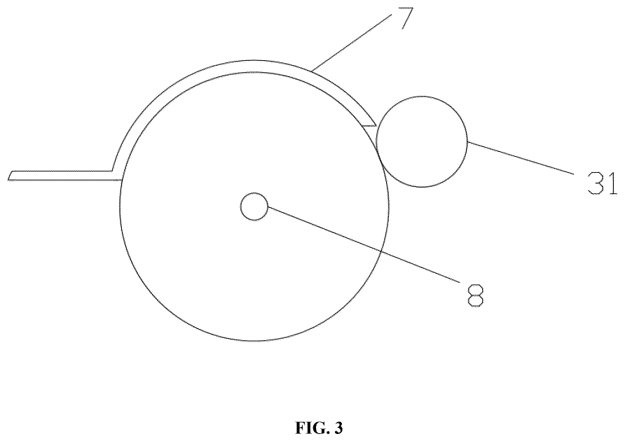

Since the gravity of the roller traction part 31 acts on the winding shaft 8 and compresses the winding shaft 8, the roller traction part 31 serves as active drive to drive the winding shaft 8 to rotate. Therefore, there is a requirement for an arrangement position of the roller traction part 31, which needs to ensure that the roller traction part 31 can drive the winding shaft 8 to rotate, without causing uneven winding of the film 7 due to an improper arrangement position. To this end, in an embodiment, an arrangement position of the roller traction part 31 is higher than an arrangement position of the winding shaft 8. When the winding shaft 8 is used for winding, the wound film 7 may be wound on the winding shaft 8 layer by layer, and a circle is actually formed by the film 7 and the winding shaft 8. Based on the machine body 1 of the digital printing machine is horizontally placed on a floor, the circle formed by the film 7 and the winding shaft 8 is divided into an upper part and a lower part. Therefore, the arrangement position of the roller traction part 31 needs to be higher than the arrangement position of the winding shaft 8 and is at a quarter circle at the upper part of the circle. If the arrangement position of the roller traction part 31 is as high as or lower than the arrangement position of the winding shaft 8, since the film 7 actually starts to be wound on the winding shaft 8 from the upper part of the circle, as shown in FIG. 3, the film 7 located at the quarter circle at the upper part of the circle may be uneven.

In addition, when the roller traction part 31 drives the winding shaft 8 to rotate, as a diameter of a master roll increases, the weight of the entire winding shaft 8 increases. The resistance to the roller traction part 31 in driving the winding shaft 8 to rotate also increases, and rotation speed of the motor is reduced. However, considering that the film 7 wound by the winding shaft 8 may be small or large, the speed needs to be lower during winding of a large film 7, to avoid a problem in the winding quality of the film 7 due to tension. To this end, in an embodiment, the roller traction part 31 includes a traction roller, a speed reducer, and a motor that are rotatably arranged on the bracket 2. The traction roller is driven by the motor. The motor is connected to the reducer. For ordinary winding of the film 7, the speed reducer does not need to be adjusted. If the winding shaft 8 needs to winds up many films 7 and a wound film 7 has a plurality of turns, the speed reducer can be turned on to cooperate with the motor to better reduce the speed of the motor, thereby avoiding the problem in the winding quality of the film 7 due to tension. In addition, in order to better avoid the paper feeding interference and improve the winding quality of the film 7, a wrap angle is provided at the traction roller, and the traction roller is in contact with the winding roller 8 at the beginning of the rotation. After the film 7 is wound, the traction roller is in contact with the film 7. Therefore, it is necessary to ensure that the traction roller can compress the film 7 without affecting the film 7. Therefore, the traction roller here is made of a solid silicon steel material. The silicon steel material has a flat surface and avoids the impact on the film 7. The purpose of making it solid is to increase the weight of the traction roller, so that the traction roller can compress the film 7.

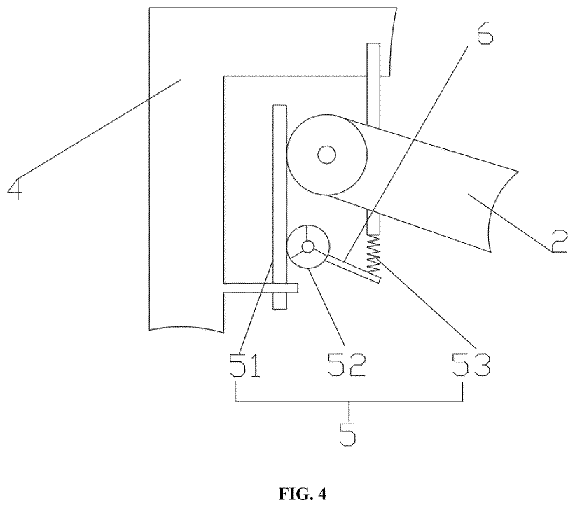

It is worth mentioning that the traction roller compresses the film 7 on the winding shaft 8, so that the winding shaft 8 may generate vibrations when winding up the film 7. As the film 7 on the winding shaft 8 is wound more, a diameter of a master roll gradually increases, which causes the bracket 2 to rotate upwards along the machine body 1. As the bracket 2 rotates upwards, an angle between the bracket 2 and the machine body 1 changes. This may cause an increase in the pressure of the traction roller on the film 7, and may also lead to a phenomenon of a film roll being loose inside and tight outside due to an excessive compression force on the film 7. To solve this problem, in an embodiment, one end of the bracket 2 is rotatably arranged on the machine body 1 of the digital printing machine through a damping mechanism 5. The damping mechanism 5 is configured to balance a pressure of the roller traction part 31 on the film 7 on the winding shaft 8. The damping mechanism 5 includes a two-rack and two-gear transmission part 51, a tooth ring drive part 52 arranged on the bracket 2, and a spring part 53. Two ends of the spring part 53 are respectively connected to the tooth ring drive part 52 and one rack of the two-rack and two-gear transmission part 51, and the tooth ring drive part 52 is meshed with the other rack of the two-rack and two-gear transmission part 51. The film 7 on the winding shaft 8 rotates by jacking the bracket 2 to drive the tooth ring drive part 52. The tooth ring drive part 52 drives the two-rack and two-gear transmission part 51 to move through the spring part 53, so that the two-rack and two-gear transmission part 51 balances the pressure on the film 7 on the winding shaft 8. The two-rack and two-gear transmission part 51 includes a gear and two racks that are respectively meshed on two sides of the gear. The two racks are slidably connected to the machine body 1 of the digital printing machine, and the gear is fixedly connected to the bracket 2. The gear and the bracket 2 rotate through the same shaft. The spring part 53 is connected to the tooth ring drive part 52 through a connecting rod 6. The connecting rod 6 is located on the tooth ring drive part 52 below the bracket 2, and the connecting rod 6 is located on a quarter arc below a tooth ring of the tooth ring drive part 52. The tooth ring drive part 52 includes the tooth ring and a rotating shaft. The rotating shaft is fixed on the machine body 1, and the tooth ring rotatably sleeves the rotating shaft. Furthermore, the connecting rod 6 is fixedly arranged on the tooth ring, and the connecting rod 6 here is not in the same plane as the tooth ring, to avoid interference with teeth on the tooth ring. When a diameter of a master roll gradually increases, the bracket 2 and the gear rotate counterclockwise. The gear drives the rack on the left to move downwards and drives the rack on the right to move upwards. The rack on the left drives the tooth ring of the tooth ring drive part 52 to rotate counterclockwise, and the tooth ring drives the connecting rod 6 to compress a spring. The spring compresses and pushes the rack on the right to slide upwards, which can cause the entire adjustment device 3 on the bracket 2 to receive an upward force. That is, if the bracket 2 rotates counterclockwise more, the compression force on the spring is higher, which can apply a higher upward force to the entire adjustment device 3 to balance the pressure on the thin film 7 on the winding shaft 8, thereby avoiding the following problem: As the bracket 2 rotates upwards, the angle between the bracket 2 and the machine body 1 changes, which can increase the compression force applied by the traction roller to the film 7 and may also lead to a phenomenon of a film roll being loose inside and tight outside due to an excessive compression force on the film 7. The counterclockwise direction, the left side, and the right side here are all based on FIG. 4. In order to better understand how to move, the counterclockwise direction, the left side, and the right side are used for description. In addition, in order to ensure a better compression force on the spring, the diameter of the tooth ring of the tooth ring drive part 52 is designed to be less than the diameter of the gear, and the connecting rod 6 is located on the quarter arc below the tooth ring of the tooth ring drive part 52, which can ensure that the spring can be compressed and jacked upwards better when the tooth ring rotates.

The working principle and usage process of the present disclosure are as follows:

During use, the rotatable bracket 2 is arranged on the machine body 1 of the digital printing machine. One end of the bracket 2 is connected to the machine body 1. The adjustment device 3 is arranged at the other end of the bracket 2. Then, the roller traction part 31 of the adjustment device 3 is rotatably arranged on the other end of the bracket 2. The roller of the roller traction part 31 abuts against the winding shaft 8. During winding of the film 7, the extensible part 33 is first adjusted, so that the extensible part 33 drives the paper pressing roller 32 to compress the film 7 on the winding shaft 8. The gravity of the roller of the roller traction part 31 can act on the winding shaft 8 to compress the winding shaft 8. When the roller traction part 31 drives the winding shaft 8 to rotate, a center rotation speed of the winding shaft 8 is constant, which is equivalent to keeping a linear speed unchanged in a uniform circular motion. As the film 7 is wound, a diameter of a master roll increases, which can reduce the rotation speed of the winding shaft 8.

When a diameter of a master roll gradually increases, the bracket 2 and the gear rotate counterclockwise. The gear drives the rack on the left to move downwards and drives the rack on the right to move upwards. The rack on the left drives the tooth ring of the tooth ring drive part 52 to rotate counterclockwise, and the tooth ring drives the connecting rod 6 to compress a spring. The spring compresses and pushes the rack on the right to slide upwards, which can cause the entire adjustment device 3 on the bracket 2 to receive an upward force. That is, if the bracket 2 rotates counterclockwise more, the compression force on the spring is higher, which can apply a higher upward force to the entire adjustment device 3 to balance the pressure on the thin film 7 on the winding shaft 8.

The above descriptions are merely the preferred embodiments of the present disclosure and are not intended to make any form of limitation on the present disclosure. Although the present disclosure has been disclosed with the preferred embodiments as mentioned above, it is not intended to limit the present disclosure. Any of those skilled in the art, without departing from the technical scope of the present disclosure, may make some changes or modifications according to the disclosed technical content to form equivalent embodiments. As long as these simple amendments, equivalent changes, and modifications fall within the contents of the technical solutions of the present disclosure according to the technical substance of the present disclosure, they shall all fall within the scope of the technical solutions of the present disclosure.

What is claimed is:

1. A digital printing film winding structure, comprising a winding shaft, a bracket, and an adjustment device, wherein two ends of the winding shaft are rotatably arranged on a machine body of a digital printing machine; one end of the bracket is rotatably arranged on the machine body of the digital printing machine; the adjustment device is arranged on an other end of the bracket; the adjustment device is configured to adjust a winding speed of the winding shaft; the adjustment device comprises a roller traction part, a paper pressing roller for pressing a film, and an extensible part connected to the paper pressing roller; the roller traction part is rotatably arranged on the other end of the bracket; a roller of the roller traction part abuts against the winding shaft; the extensible part is arranged on the bracket on one side of the roller traction part, and drives the paper pressing roller to compress a film on the winding shaft; and the roller of the roller traction part drives the winding shaft to rotate through friction with the winding shaft, to cause the winding shaft to automatically adjust a rotation speed.

2. The digital printing film winding structure according to claim 1, wherein the extensible part is arranged at two ends of the paper pressing roller, and the two extensible parts extend and contract synchronously.

3. The digital printing film winding structure according to claim 1, wherein a paper guide roller for winding paper is arranged on the bracket on an other side of the roller traction part.

4. The digital printing film winding structure according to claim 1, wherein an arrangement position of the roller traction part is higher than an arrangement position of the winding shaft.

5. The digital printing film winding structure according to claim 1, wherein the roller traction part comprises a traction roller, a speed reducer, and a motor that are rotatably arranged on the bracket; the traction roller is driven by the motor; and the motor is connected to the speed reducer.

6. The digital printing film winding structure according to claim 5, wherein the traction roller is made of solid silicon steel material.

7. The digital printing film winding structure according to claim 1, wherein one end of the bracket is rotatably arranged on the machine body of the digital printing machine through a damping mechanism; the damping mechanism is configured to balance a pressure of the roller traction part on the film on the winding shaft; the damping mechanism comprises a two-rack and two-gear transmission part, a tooth ring drive part arranged on the bracket, and a spring part; two ends of the spring part are respectively connected to the tooth ring drive part and one rack of the two-rack and two-gear transmission part, and the tooth ring drive part is meshed with the other rack of the two-rack and two-gear transmission part; by jacking the bracket to drive the tooth ring drive part, the film on the winding shaft rotates; and the tooth ring drive part drives the two-rack and two-gear transmission part to move through the spring part, so that the two-rack and two-gear transmission part balances the pressure on the film on the winding shaft.

8. The digital printing film winding structure according to claim 7, wherein the spring part and the tooth ring drive part are connected to each other through a connecting rod; the connecting rod is located on the tooth ring drive part below the bracket; and the connecting rod is located on a quarter arc below a tooth ring of the tooth ring drive part.

9. The digital printing film winding structure according to claim 7, wherein the two-rack and two-gear transmission part comprises a gear and two racks respectively meshed on two sides of the gear; and the two racks are slidably connected to the machine body of the digital printing machine.

10. The digital printing film winding structure according to claim 9, wherein a diameter of the tooth ring of the tooth ring drive part is less than a diameter of the gear.
